(19) United States
(12) Patent Application Publication
(10) Pub. No.: US 2008/0002907 A1
(43) Pub. Date: Jan. 3, 2008

(54) AUTO-EXPOSURE USING IMAGE CHARACTERSTICS

(75) Inventors: Jianhua Xu, Mill Creek, WA (US); Margaret K. Brown, Seattle, WA (US); Christopher A. Wiklof, Everett, WA (US)

Correspondence Address: GRAYBEAL, JACKSON, HALEY LLP, 155 - 108TH AVENUE NE, SUITE 350, BELLEVUE, WA, 98004-5973, US

(73) Assignee: Microvision, Inc.

(21) Appl. No.: 11/427,519

(22) Filed: Jun. 29, 2006

(51) Int. Cl. G06K 9/00; G06K 9/40

(52) U.S. Cl. 382/274; 382/162; 382/168

(57) ABSTRACT

Aspects of the subject matter described herein relate to improving images obtained from an image-acquiring system (e.g., such as a scanned laser beam camera, a scanned laser imager, or other image-acquiring system). In certain aspects, an image frame is obtained from which a histogram is created. Characteristics of the image are determined based on the histogram. These characteristics are used to make an image quality judgment regarding the image. This judgment is then used to adjust parameters in the image-acquiring system for obtaining a subsequent frame. Parameters may be adjusted even if the image is judged as normal. Other aspects are described in the specification.

### SUMMARY

Briefly, aspects of the subject matter described herein relate to improving images obtained from an image-acquiring system (e.g., such as a scanned laser beam camera, a scanned laser imager, or other image-acquiring system). In aspects, an image frame is obtained from which a histogram is created. Characteristics of the image are determined based on the histogram. These characteristics are used to make an image quality judgment regarding the image. This judgment is then used to adjust parameters in the image-acquiring system for obtaining a subsequent frame. Parameters may be adjusted even if the image is judged as normal. Other aspects are described in the specification.

This Summary is provided to briefly identify aspects of the subject matter described herein that are further described below in the Detailed Description. This Summary is not intended to identify key or essential features of the claimed subject matter, nor is it intended to be used to limit the scope of the claimed subject matter.

### BRIEF DESCRIPTION OF THE DRAWINGS

FIG. 1 is a diagram that represents a scanned-beam system according to an embodiment;

FIG. 2 is a flow diagram that generally represents actions that may occur in improving image quality according to an embodiment;

FIG. 3 is a flow diagram that generally represents actions corresponding to block 215 of FIG. 2 that may occur in creating a histogram according to an embodiment;

FIG. 4 is a flow diagram that generally represents actions corresponding to block 220 of FIG. 2 that may occur in determining characteristics of a frame according to an embodiment;

FIGS. 5-10 are exemplary histograms that may be used by an embodiment;

FIGS. 11A and 11B are flow diagrams that generally represent actions corresponding to block 225 of FIG. 2 that may occur in judging image quality according to an embodiment;

FIG. 12 is a flow diagram that represents actions corresponding to block 230 of FIG. 2 that may occur to adjust parameters for obtaining a next frame according to an embodiment;

FIG. 13 is a flow diagram that represents actions corresponding to block 1210 of FIG. 12 that may occur to determine an offset to use for obtaining a next frame according to an embodiment;

FIG. 14 is a flow diagram that represents actions corresponding to block 1215 of FIG. 12 that may occur to determine a gain for a next frame according to an embodiment;

FIG. 15 is a flow diagram that represents actions corresponding to block 1415 of FIG. 14 that may occur to determine gain for a next frame when a current frame is undersaturated according to an embodiment;

FIG. 16 is a flow diagram that represents actions corresponding to block 1425 of FIG. 14 that may occur to determine gain for a next frame when a current frame is dark according to an embodiment;

FIG. 17 is a flow diagram that represents actions corresponding to block 1435 of FIG. 14 that may occur to determine gain for a next frame when a current frame has low contrast according to an embodiment;

FIG. 18 is a flow diagram that represents actions corresponding to block 1445 of FIG. 14 that may occur to determine gain for a next frame when a current frame is oversaturated according to an embodiment;

FIG. 19 is a flow diagram that represents actions corresponding to block 1455 of FIG. 14 that may occur to determine gain for a next frame when a current frame is bright according to an embodiment;

FIG. 20 is a flow diagram that represents actions corresponding to block 1460 of FIG. 14 that may occur to determine gain for a next frame when a current frame has glare or is normal according to an embodiment; and

FIGS. 21A-21C are flow diagrams that represent actions corresponding to block 2015 of FIG. 20 that may occur to determine gain for a next frame when a current frame is normal according to an embodiment.

### DETAILED DESCRIPTION

The phrase “subject matter described herein” refers to subject matter described in the Detailed Description unless the context clearly indicates otherwise. The term “includes” should be read as “includes, but is not limited to” unless the context clearly indicates otherwise. The term “or” is an inclusive “or” operator, and is equivalent to the term “and/or”, unless the context clearly dictates otherwise. The term “an embodiment” should be read as “at least one embodiment.” The term “another embodiment” should be read as “at least one other embodiment.” The term “aspects” when used by itself is short for “aspects of the subject matter described herein.” The phrase “aspects of the subject matter described herein” should be read as “at least one feature of at least one embodiment”. Identifying aspects of the subject matter described in the Detailed Description is not intended to identify key or essential features of the claimed subject matter.

Flow diagrams are depicted in various figures below. In an embodiment, actions depicted in the flow diagrams occur in the order shown in the flow diagrams. In other embodiments, actions are constrained only by the order in which results are required and may occur in other orders or in parallel, depending upon implementation. It will be recognized by those skilled in the art that alternative actions may be substituted for actions described herein to achieve the same function or that some actions may be omitted or changed to provide the same functionality without departing from the spirit or scope of the subject matter described herein.

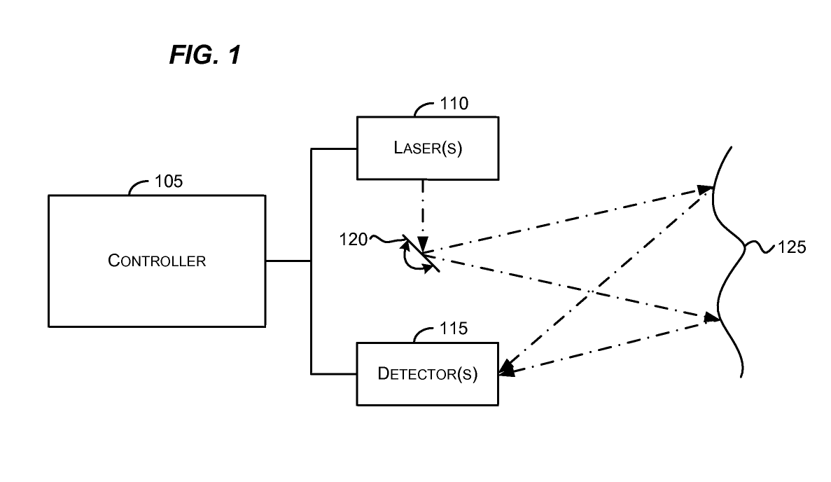

FIG. 1 is a diagram that represents a scanned-beam system according to an embodiment. The system includes a controller 105 coupled to one or more lasers 110, one or more detectors 115, and one or more laser directing elements 120. In an embodiment, the controller 105 may vary the intensity of the lasers 110 as well as the sensitivity of the detectors 115. In addition, the controller 105 may control the laser directing elements 120 to cause the light generated from the lasers 110 to be sent to various locations of a scanning area 125. In an embodiment, the laser directing elements 120 may oscillate at a known or selectable frequency. In such embodiment, the controller 105 may direct the light from the lasers 110 via the laser directing elements 120 by controlling when the lasers 110 emit light. Light that reflects from the scanning area 125 may be detected by the detectors 115. The detectors 115 may generate data or signals (hereinafter “data”) regarding the light reflected from the scanning area 125 that is sent back to the controller 105. This data may be used to generate an image frame that corresponds to the scanning area 125.

Images may be detected at a specified or selected frame rate. For example, in an embodiment, an image is detected and converted into a frame 30 times per second.

In an embodiment, light comprises visible light. In other embodiments light comprises any radiation detectable by the detectors 115 and may include any combination of infrared, ultraviolet, radio, gamma waves, x-rays, and radiation of other frequencies in the electromagnetic spectrum.

The controller 105 may comprise one or more application-specific integrated circuits (ASICs), discrete components, embedded controllers, general or special purpose processors, any combination of the above, and the like. In an embodiment, the functions of the controller 105 may be performed by various components. For example, the controller may include hardware components that interface with the lasers 110 and the detectors 115, hardware components (e.g., such as a processor or ASIC) that performs calculations based on received data, and software components (e.g., software, firmware, circuit structures, and the like) which a processor executes to perform calculations. These components may be included on a single device or distributed across more than one device without departing from the spirit or scope of the subject matter described herein.

The software components may be stored on any available machine-readable media accessible by the controller 105 and may include both volatile and nonvolatile media and removable and non-removable media. By way of example, and not limitation, machine-readable media may comprise storage media and communication media. Storage media includes both volatile and nonvolatile, removable and non-removable media implemented in any method or technology for storage of information such as machine-readable instructions, data structures, program modules, or other data. Storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the controller 105. Communication media typically embodies machine-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of machine-readable media.

In an embodiment, at least part of the scanned-beam system is part of a camera, video recorder, document scanner, other image capturing device, or the like. In an embodiment, the scanned-beam system may comprise a microelectromechanical (MEMS) scanner that operates in a progressive or bi-sinusoidal scan pattern. In other embodiments, the scanned-beam system may comprise a scanner having electrical, mechanical, optical, fluid, other components, any combination thereof, or the like that is capable of directing light in a pattern.

In an embodiment, the controller 105 may take actions based on data received from the detectors 115 as described in more detail below. In taking these actions, the controller 105 may create or obtain an image frame (hereinafter “frame”), create a histogram from the frame, determine characteristics of the frame, and adjust parameters of the detectors 115 or lasers 110 based on the characteristics of the frame. By adjusting parameters of the detectors 115 or lasers 110, including offset, gain, intensity, or other parameters, the controller 105 may be able to improve the image quality. The controller 105 may also use subsequent data received from the detectors 115 in a similar manner to continue to improve the image quality of each subsequent frame.

In aspects, improving image quality comprises causing the gray scale levels of an image to span the available dynamic range and causing the signal to noise ratio to increase. This may be done by shifting a mean value by an offset and adjusting gain. Shifting the mean value by an offset may involve adding or subtracting a determined number from each pixel of an image. In an embodiment, the controller 105 sends commands to the detectors 115 to adjust the offset, gain, or both. For example, the detectors 115 may have the ability to apply a range of offsets and gains. In another embodiment, the controller 105 may manipulate data received from the detectors 115 to adjust the offset, gain, or both digitally. In another embodiment, the detectors 115 may not receive commands to adjust offset or gain. Instead, the gain may be modified by the controller 105 by, for example, changing the gain of an amplifier connected to the detectors 115 or by modifying a bias voltage of the amplifier. In another embodiment, the amount of light detected by the detectors 115 may be effectively modified by changing the intensity of the lasers 110.

In an embodiment, the detectors 115 comprise non-imaging detectors. That is, the detectors 115 may operate without the use of a lens, pin hole, or other optical device that creates an image on a conjugate image plane. A conjugate image plane may comprise a plane upon which a lens or similar device may direct light to create an inverted image. For example, the lens of a film camera may direct light to a plane that includes a frame of the film in the camera. The light so directed forms a conjugate image on the plane that is detected by the film. As another example, a digital camera lens may direct light to an array of detectors (CCD detectors) within the camera. Again, the directed light may form an inverted image on the array of detectors and using light and spatial information associated with the detectors (e.g., how much light and of what type was received at each detector together with the location of the detector) an image may be formed.

In such embodiment, the detectors 115 may comprise positive intrinsic negative (PIN) diodes, avalanche photo diodes (APDs), photomultiplier tubes, or the like that detect light that reaches the detectors 115 from any path. Based on the area to which the laser directing elements 120 were directing light at or near the time the light reaches the detectors 115, light detected by the detectors 115 may be attributed to the area in the scanning area 125 and assigned to a pixel (e.g., via the controller 105, a portion thereof, or other circuitry) and may be used to form an image (e.g., via the controller 105, a portion thereof, or other circuitry).

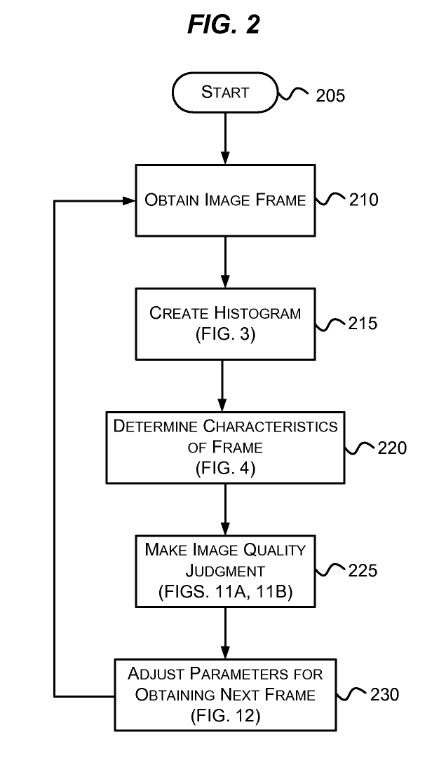

FIG. 2 is a flow diagram that generally represents actions that may occur in improving image according to an embodiment. At block 205 the actions begin.

At block 210, a frame is obtained. As described previously in conjunction with FIG. 1, a frame may be obtained by manipulating data sent from a detector. In an embodiment, image data that was previously captured and placed in storage may be obtained by retrieving the data from the storage and creating a frame using the data. A particular image capturing device (e.g., a camera) may have a fixed or adjustable resolution. In an embodiment, an image capturing device that includes a MEMS scanner may have a resolution that approximates 800 by 600 pixels. A frame may be created from such a device based on the resolution of the device.

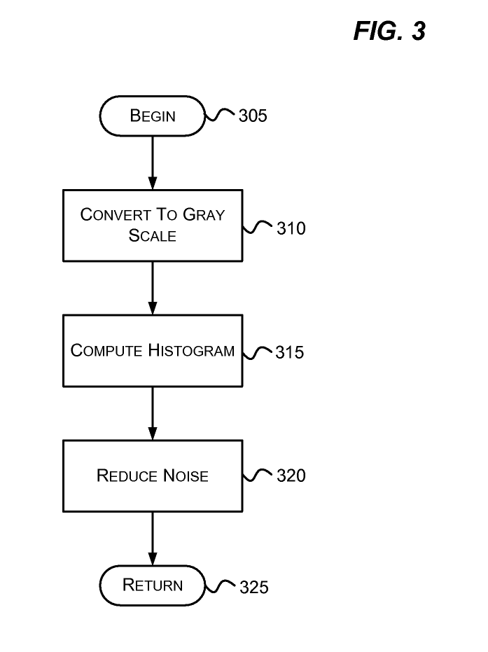

At block 215, a histogram of the frame is created as described in more detail in conjunction with FIG. 3.

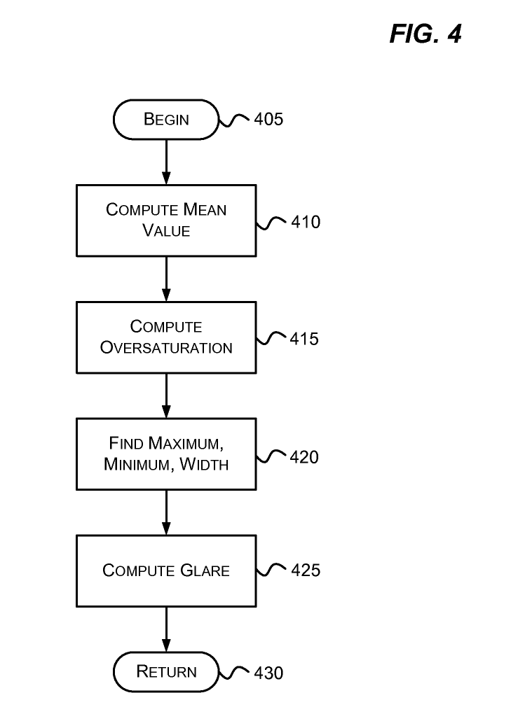

At block 220, this histogram may then be used to determine characteristics of the frame as described in more detail in conjunction with FIG. 4.

At block 225, the characteristics may be used to make an image quality judgment regarding the frame. For example, the controller may use the characteristics to determine that the frame is normal, dark, undersaturated, oversaturated, or bright or has glare or low contrast.

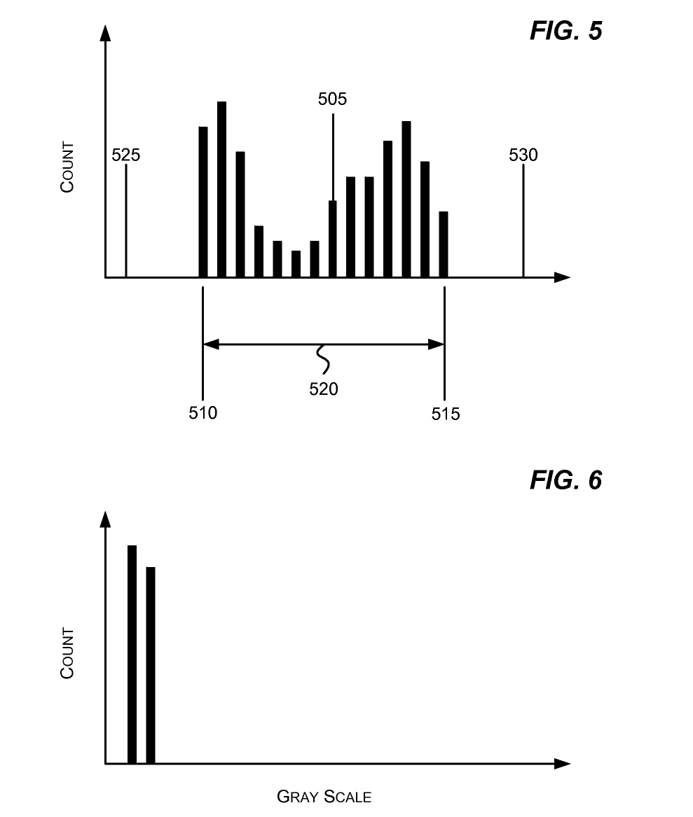

At block 230, the characteristics and image quality judgment may be used to adjust parameters for obtaining the next frame as described in more detail in conjunction with FIG. 5.

FIG. 3 is a flow diagram that generally represents actions corresponding to block 215 of FIG. 2 that may occur in creating a histogram according to an embodiment. At block 305, the actions begin.

At block 310, the image or a portion thereof is converted to a gray scale image if needed. A portion of the image may be selected to reduce computation time or increase accuracy (e.g., by working on the portion of interest). Throughout this document, the term image refers to a complete image or portion thereof, unless the context clearly dictates otherwise. If an image is obtained in gray scale, gray scale conversion may not be needed. When a color image is represented in RGB, one suitable formula for converting the image to a gray scale image is to apply the following formula to each pixel of the color image:

GSPixel[p]=0.21·R[p]+0.27·G[p]+0.07·B[p]

where p is an index of the pixel being converted, GSPixel is a buffer to hold the gray scale image, and R, G, and B are buffers that hold the red, green, and blue color channels of the color image, respectively. The constants, 0.21, 0.72, 0.07 may be selected to correspond to a gray scale image that is good for human vision and in analyzing a histogram. Other constants may be chosen as appropriate depending on implementation.

At block 315, a gray scale histogram is computed for the gray scale image. This may be performed by creating an array of the possible gray scale values (e.g., 0 to 255), initializing the values of the array to 0, traversing each pixel in the gray scale image, and adding to an appropriate gray scale element of the array each time a pixel having a corresponding gray scale value is traversed.

At block 320, a noise reduction operation may be performed on the histogram to reduce noise. One suitable noise reduction algorithm may comprise forming a histogram with fewer values (e.g., 0 to 63) than the original histogram and placing intervals (e.g., 0 to 3, 4 to 7, . . . , 252 to 255) of original histogram values into their corresponding values in the second histogram (e.g., 0, 1, . . . , 63). Thereafter, characteristics of the histogram (e.g., mean value, maximum value, minimum value, and so forth) may be calculated by integrally dividing each value of the second histogram by a noise factor and then multiplying each characteristic by the interval value, wherein the interval value is the number of elements in each interval (e.g., 4 in the example above). Integrally dividing, in this sense, means dividing by an integer and throwing away the remainder. The larger the noise factor, the more noise (and non-noise) may be removed. The noise factor may be computed based on the noise characteristics of the scanned-beam system. In a MEMS based scanned-beam system with a resolution of 800 by 600, one suitable noise factor is 12. Other noise factors may be appropriate depending on the noise characteristics of a given scanned-beam system.

It will be recognized that other noise-reduction algorithms and mechanisms may be used to reduce noise without departing from the spirit or scope of the subject matter described herein. Further, it will be recognized that such noise-reduction algorithms and mechanisms may be used before, during, or after computing a histogram.

At block 325, the actions return and continue at block 220 of FIG. 2.

FIG. 4 is a flow diagram that generally represents actions corresponding to block 220 of FIG. 2 that may occur in determining characteristics of a frame according to an embodiment. At block 405 the actions begin.

At block 410 the mean value of the histogram is computed. As mentioned previously, noise may be reduced by producing a second histogram with fewer values (e.g., 64) and then integrally dividing each element in the second histogram array by a noise factor in conjunction with computing the mean value. For example, with a noise factor of 12, histogram elements representing less than 12 pixels are treated as noise and not used in the calculation of the mean. For example, referring to FIG. 5, a mean 505 may be computed. An exemplary formula for calculating a mean value is as follows:

Mean=Intervals·Σᵢ₌₀ⁿ⁻¹i·H(i)/NoiseFactor/Σᵢ₌₀ⁿ⁻¹H(i)/NoiseFactor

Where n is the number of elements in the reduced histogram (e.g., 64), Intervals is the number by which the original histogram was divided to produce the reduced histogram (e.g., 4), H(i) is the value of the i^{th} element of the reduced histogram and H(0) is the leftmost element of the reduced histogram, and NoiseFactor is a selected noise factor.

At block 415, an oversaturated value may be computed by the following formula:

OversaturatedValue=SubSampleFactor·Σᵢ₌ⱼ₋₁ⁿ⁻¹H(i)/NoiseFactor

where j is a selected value near the right end of the histogram, n is the number of elements in the reduced histogram (e.g., 64), H(i) is the value of the i^{th} element of the reduced histogram and H(0) is the leftmost element of the reduced histogram, NoiseFactor is a selected noise factor, and SubSampleFactor is a selected sampling value.

To decrease the time to calculate a histogram, not every pixel of the image may be used. This is sometimes referred to as sampling or sampled. In an embodiment, the number of pixels sampled is the total number of pixels divided by a value (e.g., SubSampleFactor). The pixels used to calculate the histogram may be selected by skipping a selected number (e.g., SubSampleFactor) of rows or columns of pixels between each pixel. For example, for an image frame having dimensions of 600 by 800 pixels, a histogram H may be calculated as follows:

for (i=0; i<600; i+=SubSampleFactor) {for (j=0; j<800; j++) {H[frame[i][j]]++; }}

Pixels between the selected pixels may be assumed to have the same gray scale values as the selected pixels. To add these non-sampled pixels, one may multiply by the SubSampleFactor.

At block 420, the minimum, maximum, and width of the histogram may be computed. For example, referring to FIG. 5, a minimum 510, a maximum 515, and a width 520 may be computed.

At block 425, a glare value may be computed by the following formula:

Glare=SubSampleFactor·Σᵢ₌ₙ₋ₖ₋₁ⁿ⁻¹H(i)

where n is the number of elements in the original histogram, k is the number of histogram elements that are to be included in the glare calculation, H(i) is the value of the i^{th} element and H(0) is the leftmost element of the original histogram, and SubSampleFactor is a selected sampling value.

Glare may show as a spike in the rightmost element values of a histogram. It typically means that some part of the image is very bright. In an embodiment including a MEMS based scanned-beam system with a resolution of 800 by 600, sensitivity of 8 bits, and histogram of 256 elements (e.g., 0 to 255) (hereinafter “the exemplary MEMS based system”), setting k=2 may be used to calculate glare. Other embodiments may dictate other values for k depending on device characteristics. Selecting an appropriate k may be accomplished by scanning several images with glare and selecting a k based thereon.

FIGS. 5-10 are exemplary histograms that may be used by an embodiment. Turning to FIG. 5, each histogram may include a mean 505, a minimum 510, a maximum 515, a dynamic range low 525, and a dynamic range high 530. The dynamic range low 525 and the dynamic range high 530 may be the extent of ranges that are able to be detected by light detectors (e.g., light detectors 115 of FIG. 1).

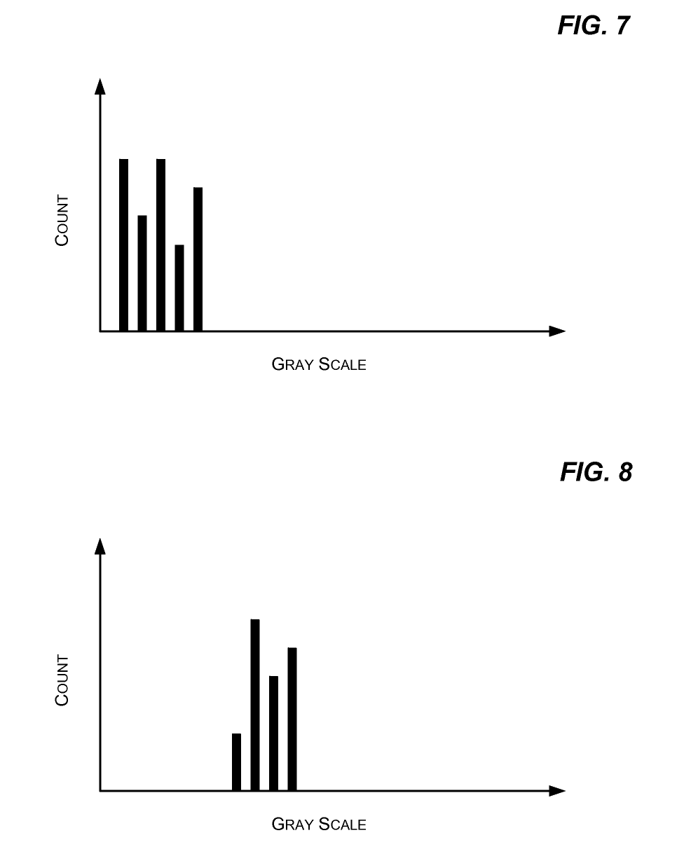

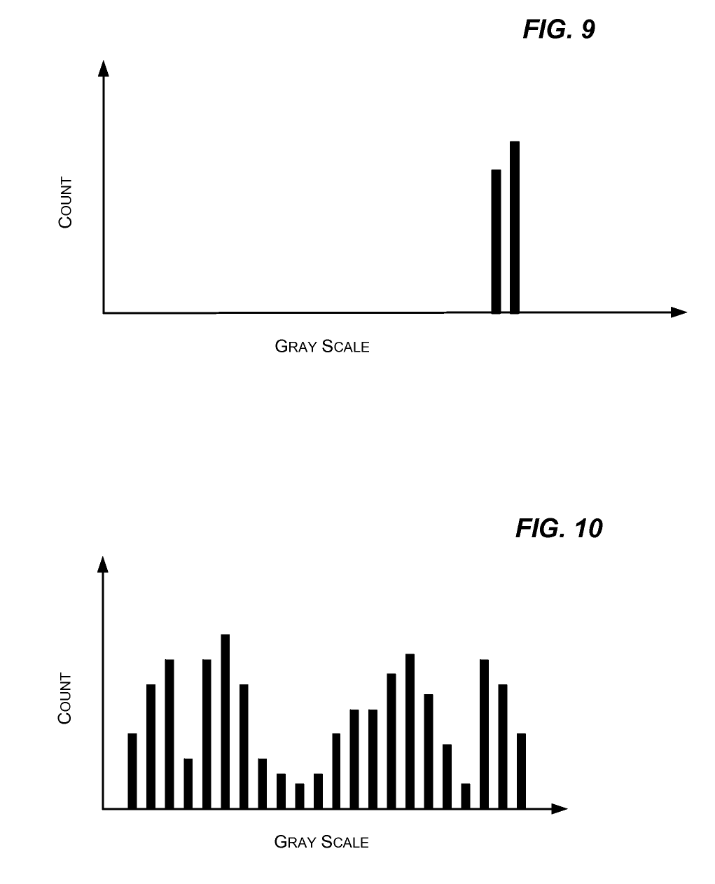

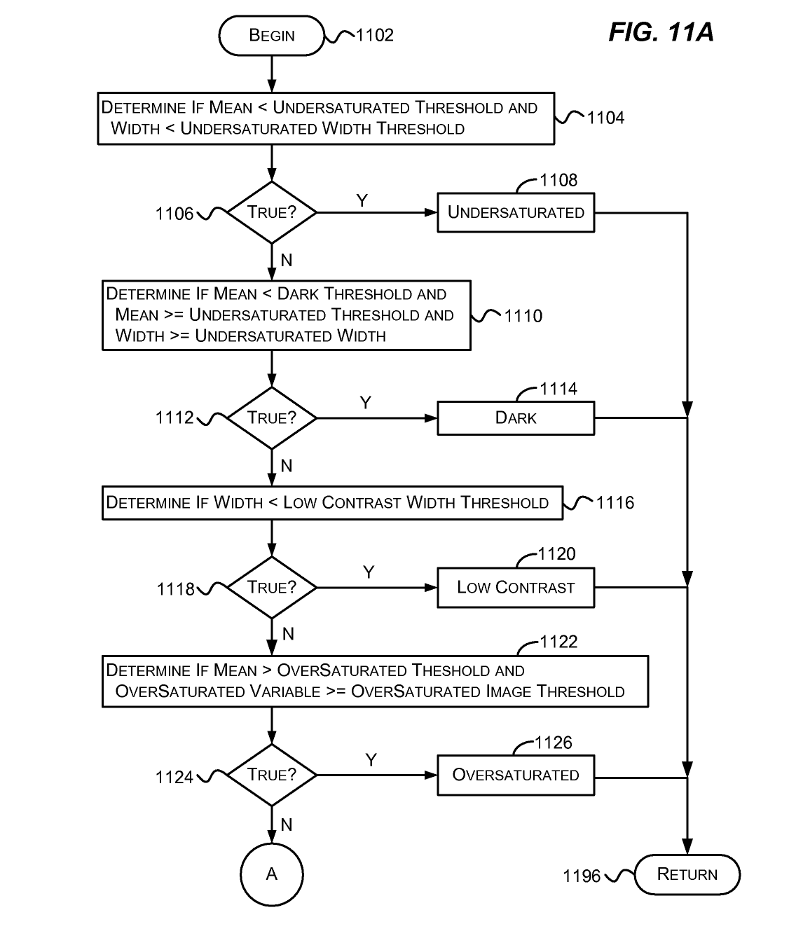

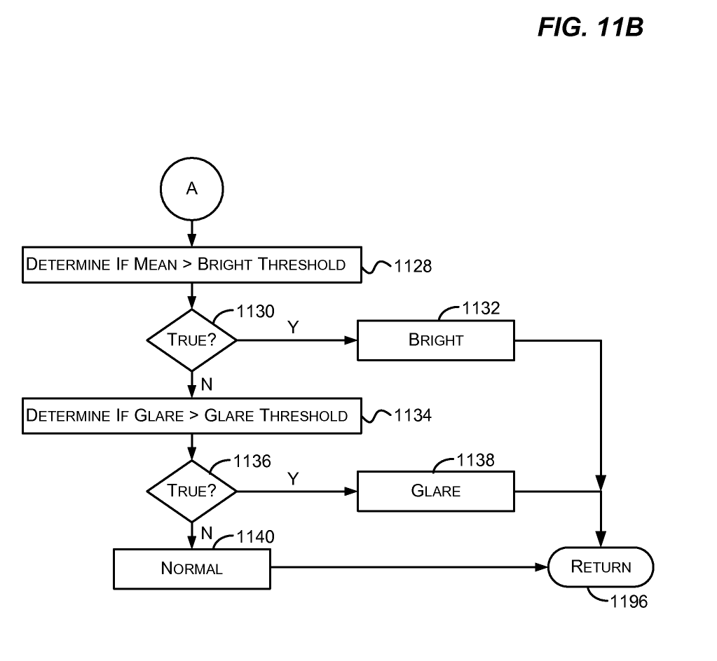

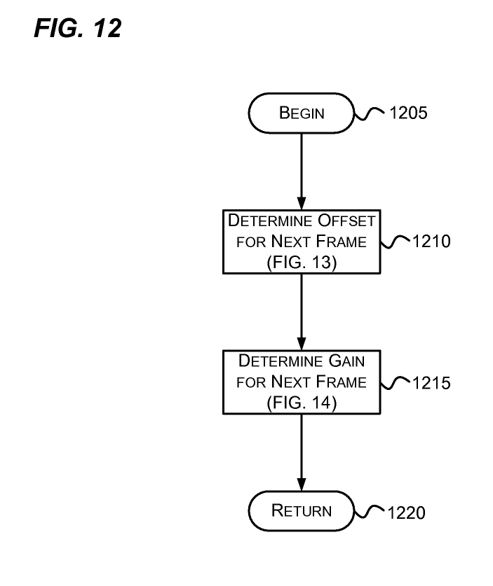

In FIG. 6 the image associated with the histogram may be considered undersaturated. In FIG. 7, the image associated with the histogram may be considered dark. In FIG. 8, the image associated with the histogram may be considered to have low contrast. In FIG. 9, the image associated with the histogram may be considered to be oversaturated. In FIG. 10, the image associated with the histogram may be considered to be normal. It will be understood, however, that additional or different classifications for the histograms may be given without departing from the spirit or scope of the subject matter described herein.

In each of FIGS. 6-9, the image associated with each histogram has one or more problems that may make it difficult to see details associated with the image. For example, in FIG. 8, the image associated with the histogram may be considered to have low contrast. To provide better contrast for a subsequently obtained frame, an offset and gain may be applied to attempt to spread the color values over more of the dynamic range of the detectors. The offset may cause the color values to approach the lower end of the dynamic range while the gain may cause the colors to spread and to approach the upper end of the dynamic range. Similarly, for the images associated with the other figures, the offset and gain may be adjusted as described in more detail below to provide for a better image in a subsequently obtained frame, where better means causing the gray scale levels to span more of the available dynamic range and causing the image to have a higher signal to noise ratio.

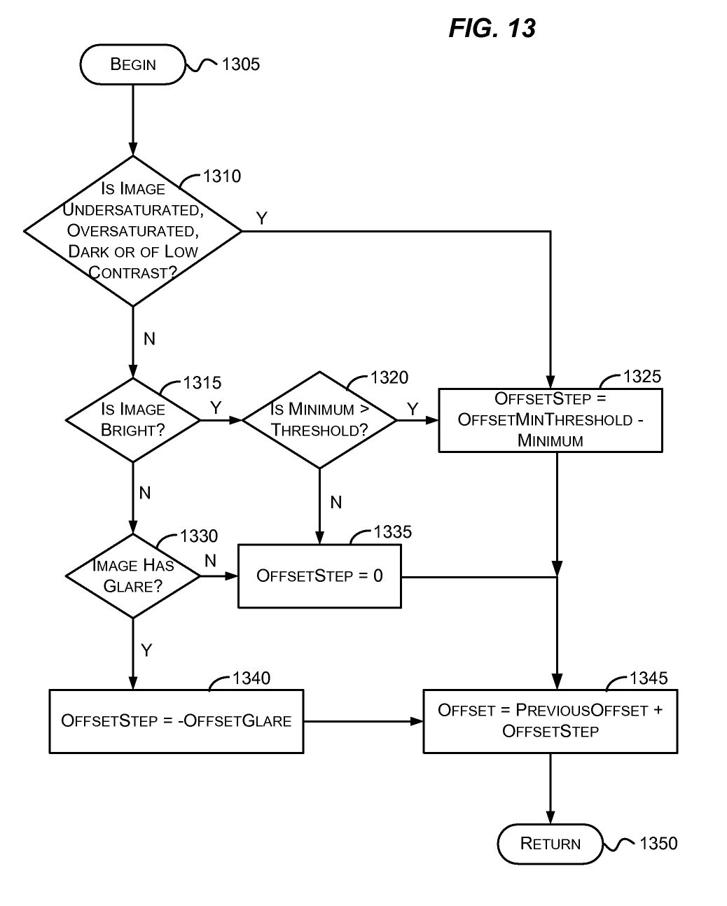

FIGS. 11A and 11B are flow diagrams that generally represent actions corresponding to block 225 of FIG. 2 that may occur in judging image quality according to an embodiment. Turning to FIG. 11A, at block 1102, the actions begin.

At block 1104, a determination is made as to whether the mean of the histogram is less than the undersaturated threshold and the width is less than the undersaturated width threshold. If so, at block 1106, the actions continue at block 1108; otherwise, the actions continue at block 1110. In the exemplary MEMS based system discussed previously, an exemplary undersaturated threshold is 8 and an exemplary undersaturated width threshold is 36. In an embodiment, an undersaturated image is an image in which no or very little details regarding the image can be seen.

In an embodiment, determining whether an image is undersaturated may proceed in a manner similar to how glare is determined (as described below). Namely, the values of a histogram on the left of the histogram may be added together to form an undersaturated value (similarly to how the glare value was calculated previously) and then the undersaturated value may be compared against an undersaturated threshold. If the undersaturated value is greater than the undersaturated threshold, the image may be considered to be undersaturated.

At block 1108, the image is judged as undersaturated and a variable is set to indicate this judgment.

At block 1110, a determination is made as to whether the mean is less than a dark threshold and greater than or equal to an undersaturated threshold and also whether the width is greater than or equal to an undersaturated width. If so, at block 1112, the actions continue at block 1114; otherwise the actions continue at block 1116. In the exemplary MEMS based system discussed previously, an exemplary dark threshold is 96, an exemplary undersaturated threshold is 8, and an exemplary undersaturated width threshold is 36.

At block 1114, the image is judged as dark and a variable is set to indicate this judgment.

At block 1116, a determination is made as to whether the width is less than a low contrast width threshold. If so, at block 1118, the actions continue at block 1120; otherwise, the actions continue at block 1122. In the exemplary MEMS based system discussed previously, an exemplary low contrast width threshold is 132.

At block 1120, the image is judged as having low contrast and a variable is set to indicate this judgment.

At block 1122 a determination is made as to whether the mean is greater than an oversaturated threshold and whether an oversaturated value is greater than or equal to an oversaturated image threshold. If so, at block 1124, the actions continue at block 1126; otherwise, the actions continue at block 1128 of FIG. 11B. In the exemplary MEMS based system discussed previously, an exemplary oversaturated threshold is 224 and an exemplary oversaturated image threshold is 20,000.

At block 1126, the image is judged as oversaturated and a variable is set to indicate this judgment.

Turning to FIG. 11B, at block 1128, a determination is made as to whether the mean is greater than a bright threshold. If so, at block 1130, the actions continue at block 1132; otherwise, the actions continue at block 1134. In the exemplary MEMS based system discussed previously, an exemplary bright threshold is 160.

At block 1132, the image is judged as bright and a variable is set to indicate this judgment.

At block 1134, a determination is made as to whether the glare value is greater than a glare threshold. If so, at block 1136, the actions continue at block 1138; otherwise, the actions continue at block 1140. In the exemplary MEMS based system discussed previously, an exemplary glare threshold is 18,000.

At block 1138, the image is judged as having glare and a variable is set to indicate this judgment.

At block 1140, the image is judged as being normal. In aspects of the subject matter described herein, a normal image is an image that is not dark, undersaturated, oversaturated, light, or has low contrast or glare. In other aspects, a normal image may be considered to be an image in which the mean of the histogram is approximately at the middle of the histogram (plus or minus a threshold) and wherein the width of the histogram is approximately the width of the dynamic range (plus or minus a threshold).

It will be recognized that the thresholds mentioned above may vary from device to device based on sensitivity, dynamic range, and so forth and may be calculated or determined by causing the scanned-beam system to scan images of known types and selecting the thresholds based thereon.

At block 1196, the actions continue at block 230 of FIG. 2.

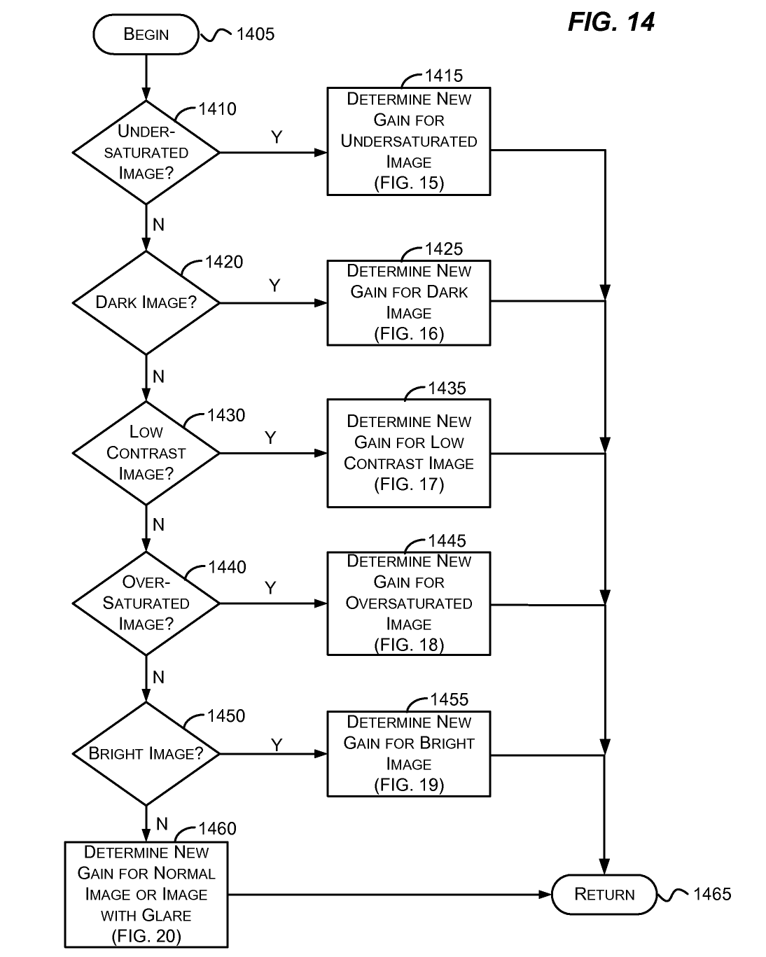

FIG. 12 is a flow diagram that represents actions corresponding to block 230 of FIG. 2 that may occur to adjust parameters for obtaining a next frame according to an embodiment. As mentioned previously, offset and gain are two parameters that may be adjusted to improve image quality in subsequent frames. These parameters may be determined based on characteristics of a current frame together with a judgment of the image quality of the current frame. At block 1205, the actions begin.

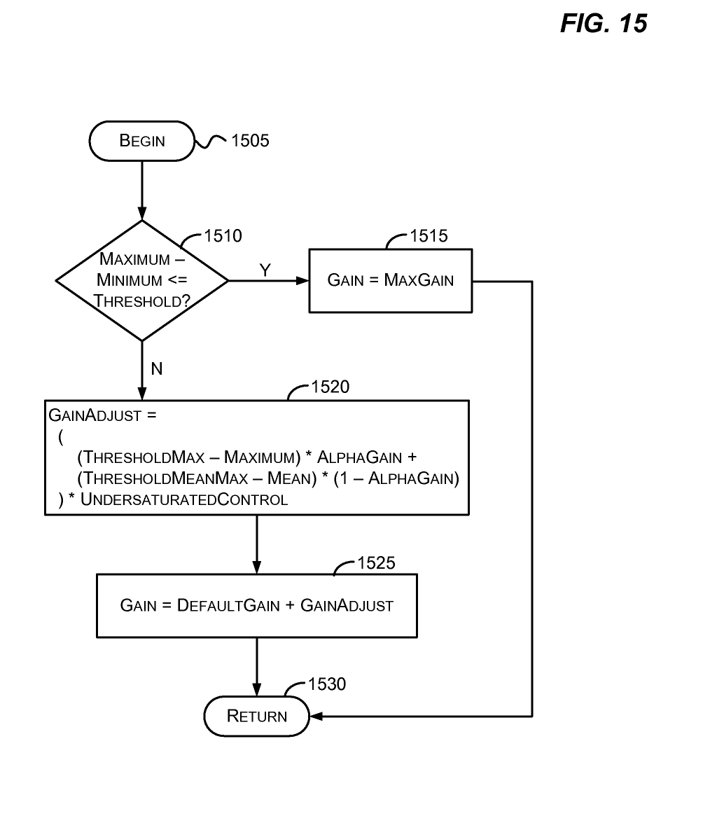

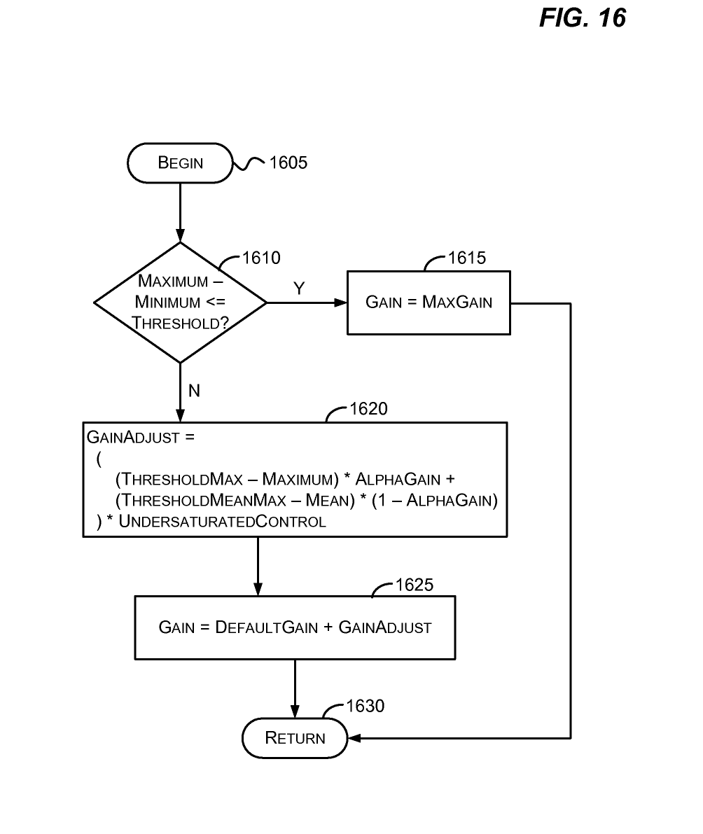

At block 1210, an offset is determined as described in more detail in conjunction with FIG. 13. At block 1215, a gain is determined as described in more detail in conjunction with FIG. 14. At block 1220, the actions return and continue at block 210 of FIG. 2 where the next image frame is obtained using the parameters.

FIG. 13 is a flow diagram that represents actions corresponding to block 1210 of FIG. 12 that may occur to determine an offset to use for obtaining a next frame according to an embodiment. At block 1305, the actions begin.

At block 1310, a determination is made as to whether the previously-determined image quality is undersaturated, oversaturated, dark, or of low contrast. If so, the actions continue at block 1325; otherwise, the actions continue at block 1315. At block 1325, the offset step is set equal to an offset minimum threshold (e.g., 0) minus the minimum found for the current frame. In conjunction with the gain adjustment described in more detail in FIG. 14, this has an effect of expanding the range of the next frame.

At block 1315, a determination is made as to whether the previously-determined image quality is bright. If so, the actions continue at block 1320; otherwise, the actions continue at block 1330. At block 1320, a determination is made as to whether the minimum found for the current frame is greater than a threshold. If so, the actions continue at block 1325; otherwise, the actions continue at block 1335. In the exemplary MEMS based system, in an embodiment, a suitable threshold is 96.

At block 1330, a determination is made as whether the previously-determined image quality has glare. If so, the actions continue at block 1340; otherwise, the actions continue at block 1335. At block 1340, the offset step is set to the negative of OffsetGlare. In the exemplary MEMS based system, in an embodiment, one suitable OffsetGlare is 2. At block 1335, the offset step is set to zero which has the effect of causing the offset to remain the same for the subsequent frame.

At block 1345, the offset for the next frame is set equal to the offset for the current frame plus the offset step. In some instances (e.g., where the offset step is 0), this has the effect of setting the offset for the next frame to be the same as the offset for the current frame. If setting the offset according to block 1345 causes the offset to be outside a range of allowable values, the offset may be set to the maximum or minimum of the range, whichever is closer.

At block 1350, the actions return and continue at block 1215 of FIG. 12.

FIG. 14 is a flow diagram that represents actions corresponding to block 1215 of FIG. 12 that may occur to determine a gain for a next frame according to an embodiment. At block 1405, the actions begin.

At blocks 1410, 1420, 1430, 1440, and 1450, a determination is made as to whether the previously-determined image quality is undersaturated, dark, has low contrast, is oversaturated, or bright, respectively. If so, processing continues at blocks 1415, 1425, 1435, 1440, and 1455, respectively. Otherwise, processing continues at blocks 1420, 1430, 1440, 1450, and 1460 respectively.

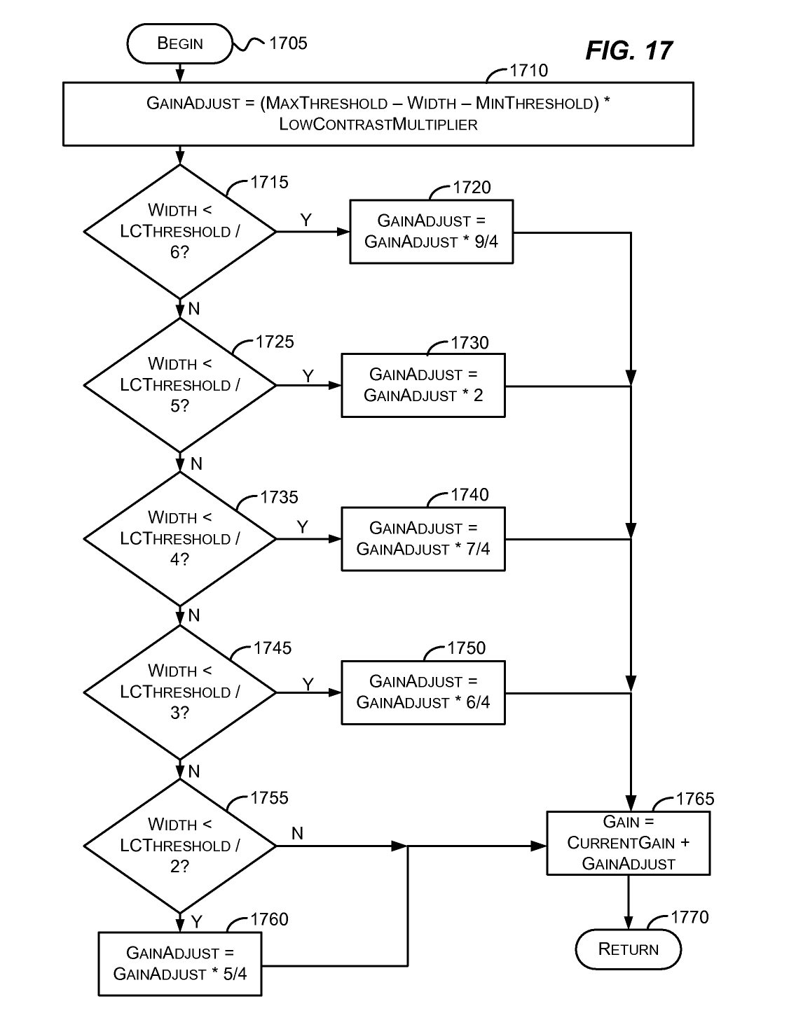

At blocks 1415, 1425, 1435, 1445, and 1455, a gain for the next frame is determined depending on the current image quality as described in more detail in conjunction with FIGS. 15, 16, 17, 18, and 19 respectively.

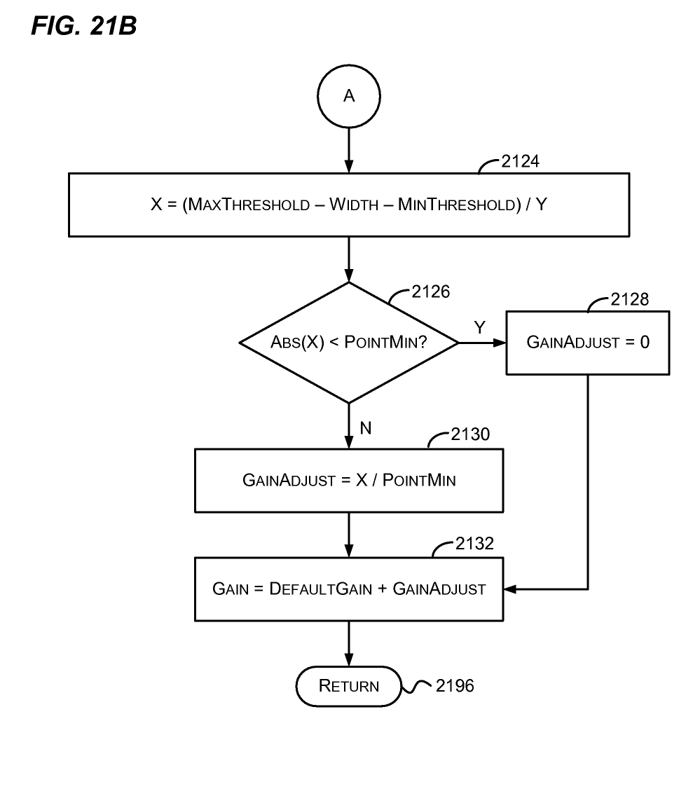

At block 1460, a gain for the next frame is determined for a normal image or an image with glare as described in more detail in conjunction with FIG. 20.

At block 1465, the actions return and continue at block 1220 of FIG. 12.

Note that although FIG. 14 provides a mechanism in which a test is performed for each type of image quality and gains computed based thereon, it will be recognized that some of the gain calculations may be the same for different types of images and that code may be reused in some cases as desired.

FIG. 15 is a flow diagram that represents actions corresponding to block 1415 of FIG. 14 that may occur to determine gain for a next frame when a current frame is undersaturated according to an embodiment. At block 1505, the actions begin.

At block 1510, a determination is made as to whether the maximum−the minimum (e.g., the width) previously determined is less than or equal to a threshold. If so, the actions continue at block 1515 where the gain is set to the maximum gain allowed. When the width is very small, more gain may be needed to increase the detail. In the exemplary MEMS based system, in an embodiment, one suitable threshold is 4.

At block 1520, a variable (e.g., GainAdjust) is set according to the following formula:

GainAdjust=((TMax−Max)·AG+(TMM−Mean)·(1−AG))·UC

where TMax is a selected maximum threshold Max is the maximum of the histogram for the current frame, AG is a selected gain, TMM is a selected maximum mean threshold, Mean is the mean of the histogram for the current frame, and UC is a selected multiplication factor. In the exemplary MEMS based system, in an embodiment, some suitable values for TMax, AG, TMM, and UC are 252, 0.5, 196, and 20, respectively.

At block 1525, the gain for obtaining the next frame is set to a selected default gain plus the GainAdjust calculated above. In the exemplary MEMS based system, in an embodiment, one suitable default gain is approximately 1.

At block 1530, the actions continue at block 1465 of FIG. 14.

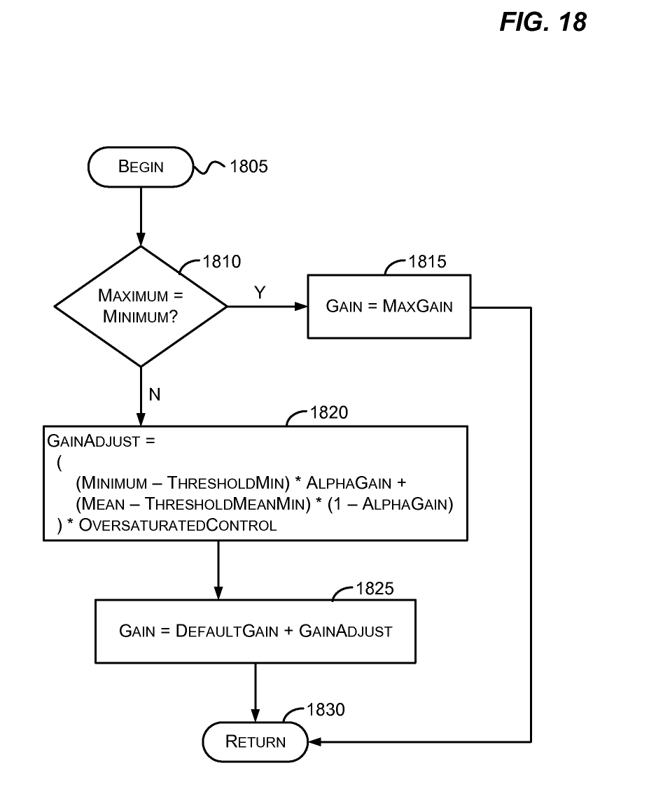

FIG. 16 is a flow diagram that represents actions corresponding to block 1425 of FIG. 14 that may occur to determine gain for a next frame when a current frame is dark according to an embodiment. At block 1605, the actions begin.

At block 1610, a determination is made as to whether the maximum−the minimum (e.g., the width) previously determined is less than or equal to a threshold. If so, the actions continue at block 1615 where the gain is set to the maximum gain allowed. When the width is very small, more gain may be needed to increase the detail available. In the exemplary MEMS based system, in an embodiment, one suitable threshold is 4.

At block 1620, a variable (e.g., GainAdjust) is set according to the following formula:

GainAdjust=((TMax−Max)·AG+(TMM−Mean)·(1−AG))·DC

where TMax is a selected maximum threshold, Max is the maximum of the histogram for the current frame, AG is a selected gain, TMM is a selected maximum mean threshold, Mean is the mean of the histogram for the current frame, and DC is a selected multiplication factor. In the exemplary MEMS based system, in an embodiment, some suitable values for TMax, AG, TMM, and UC are 252, 0.5, 196, and 2, respectively.

At block 1625, the gain is set to a selected default gain plus the GainAdjust calculated above. In the exemplary MEMS based system, in an embodiment, one suitable default gain is approximately 1.

At block 1630, the actions continue at block 1465 of FIG. 14.

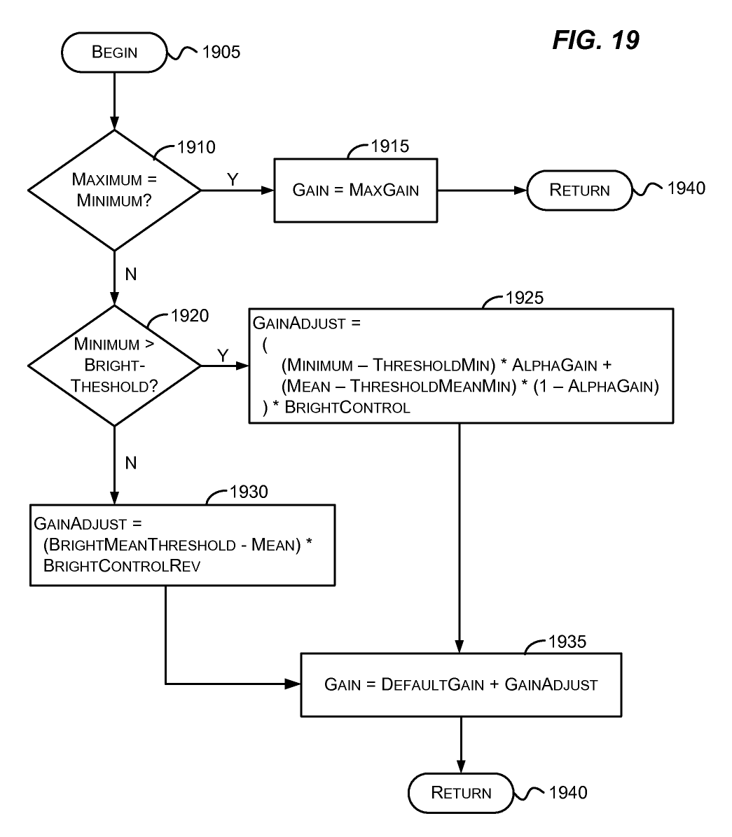

FIG. 17 is a flow diagram that represents actions corresponding to block 1435 of FIG. 14 that may occur to determine gain for a next frame when a current frame has low contrast according to an embodiment. At block 1705, the actions begin.

At block 1710 a variable (e.g., GainAdjust) is set to according to the following formula:

GainAdjust=(TMax−Width−TMin)·LCM

where TMax is a selected maximum threshold, width is the width of histogram for the current frame, TMin is a selected minimum threshold, and LCM is a selected low contrast multiplier. In the exemplary MEMS based system, in an embodiment, some suitable values for TMax, TMin, and LCM are 252, 0, and 7, respectively.

At block 1715, a determination is made as to whether the width is less than a low contrast threshold divided by six. If so, the actions continue at block 1720; otherwise, the actions continue at block 1725. In the exemplary MEMS based system, in an embodiment, one suitable value of the low contrast threshold is 132. In an embodiment, the smaller the width, the more gain that is needed to increase the contrast. At block 1720, the GainAdjust is multiplied by 9/4.

At block 1725, a determination is made as to whether the width is less than a low contrast threshold divided by 5. If so, the actions continue at block 1730; otherwise, the actions continue at block 1735. At block 1730, the GainAdjust is doubled.

At block 1735, a determination is made as to whether the width is less than a low contrast threshold divided by 4. If so, the actions continue at block 1740; otherwise, the actions continue at block 1745. At block 1740, the GainAdjust is multiplied by 7/4.

At block 1745, a determination is made as to whether the width is less than a low contrast threshold divided by 3. If so, the actions continue at block 1750; otherwise, the actions continue at block 1755. At block 1750, the GainAdjust is multiplied by 6/4 (i.e., 1.5).

At block 1755, a determination is made as to whether the width is less than a low contrast threshold divided by 2. If so, the actions continue at block 1760; otherwise, the actions continue at block 1765. At block 1760, the GainAdjust is multiplied by 5/4.

At block 1765, the gain for the obtaining the next frame is set to the gain of the current frame plus the GainAdjust.

At block 1770, the actions continue at block 1465 of FIG. 14.

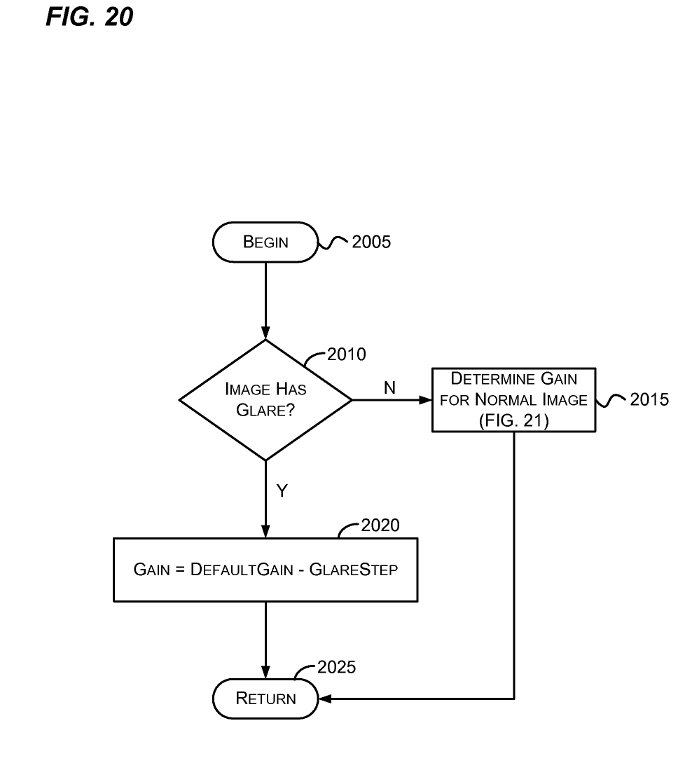

FIG. 18 is a flow diagram that represents actions corresponding to block 1445 of FIG. 14 that may occur to determine gain for a next frame when a current frame is oversaturated according to an embodiment. At block 1805, the actions begin.

At block 1810, a determination is made as to whether the maximum of the histogram is equal to the minimum of the histogram (i.e., whether the width is 1). If so, processing branches to block 1815 in which the gain is set to a maximum gain allowed by the scanned-beam system.

At block 1820 a variable (e.g., GainAdjust) is set to according to the following formula:

GainAdjust=((Min−TMin)·AG+(Mean−TMMin)·(1−AG))*OSC

where Min is the minimum of the current frame, TMin is a selected minimum threshold, AG is a selected gain, Mean is the mean of the histogram for the current frame, TMMin is a selected minimum threshold, and OSC is a selected oversaturated multiplier. In the exemplary MEMS based system, in an embodiment, some suitable values for TMin, AG, TMMin, and OSC are 0, 0.5, and 4, respectively.

At block 1825, the gain is set to a selected default gain plus the GainAdjust calculated above.

At block 1830, the actions continue at block 1465 of FIG. 14.

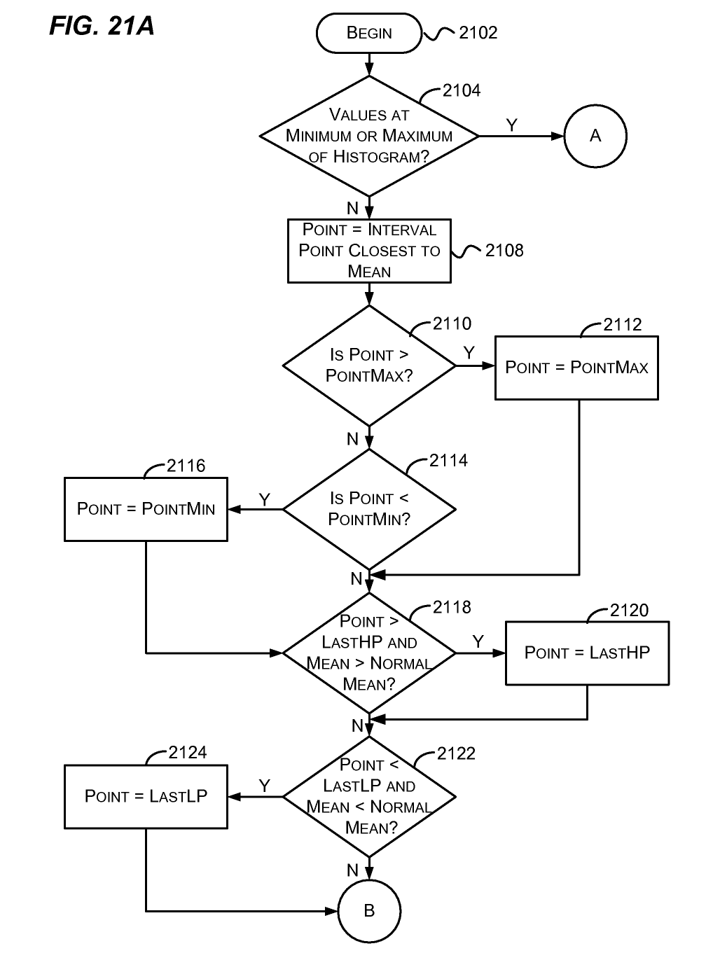

FIG. 19 is a flow diagram that represents actions corresponding to block 1455 of FIG. 14 that may occur to determine gain for a next frame when a current frame is bright according to an embodiment. At block 1905, the actions begin.

At block 1910, a determination is made as to whether the maximum of the histogram is equal to the minimum of the histogram (i.e., whether the width is 1). If so, processing branches to block 1915 in which the gain is set to a maximum gain allowed by the scanned-beam system.

At block 1920, a determination is made as to whether the minimum of the histogram is greater than a selected bright threshold. If so, the actions continue at block 1925; otherwise, the actions continue at block 1930. In the exemplary MEMS based system, in an embodiment, one suitable bright threshold is 160.

At block 1925, a variable (e.g., GainAdjust) is set according to the following formula:

GainAdjust=((Min−TMin)·AG+(Mean−TMMin)·(1−AG))·BC

where Min is the minimum of the current frame, TMin is a selected minimum threshold, AG is a selected gain, Mean is the mean of the histogram for the current frame, TMMin is a selected minimum mean threshold, and BC is a selected bright multiplier. In the exemplary MEMS based system, in an embodiment, some suitable values for TMin, AG, TMMin, and BC are 0, 0.5, 32, and 6, respectively.

At block 1930, a variable (e.g., GainAdjust) is set according to the following formula:

GainAdjust=(BMT−Mean)·BCR

where BMT is a selected bright mean threshold, Mean is the mean of the histogram for the current frame, and BCR is a selected bright multiplier. In the exemplary MEMS based system, in an embodiment, some suitable values for BMT and BCR are 160 and 2, respectively.

At block 1935, the gain is set to a selected default gain plus the GainAdjust calculated above.

At block 1940, the actions continue at block 1465 of FIG. 14.

FIG. 20 is a flow diagram that represents actions corresponding to block 1460 of FIG. 14 that may occur to determine gain for a next frame when a current frame has glare or is normal according to an embodiment. The actions begin at block 2005.

At block 2010, a determination is made as to whether the image has glare. This may be done by using the image judgment previously determined. If the image has glare, the actions continue at block 2020; otherwise, the actions continue at block 2015.

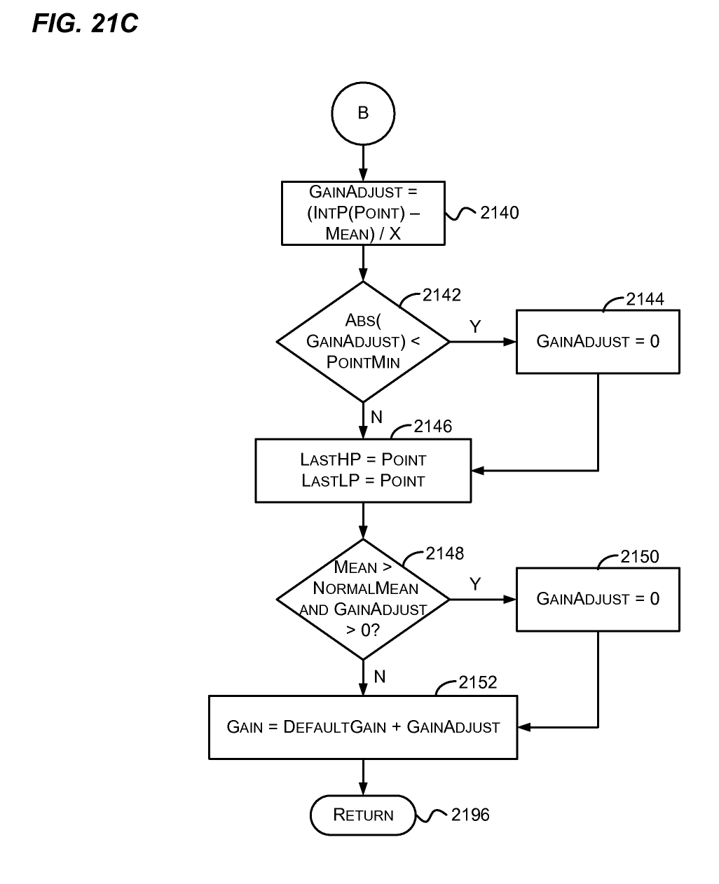

At block 2015, the gain for the next frame is determined for a normal image as described in more detail in conjunction with FIG. 21.

At block 2020, the gain for the next frame is set equal to a selected default gain minus a selected glare step. In the exemplary MEMS based system, in an embodiment, some suitable values for default gain and glare step are approximately 1 and 2, respectively.

At block 2025 the actions continue at block 1465 of FIG. 14.

FIGS. 21A-21C are flow diagrams that represent actions corresponding to block 2015 of FIG. 20 that may occur to determine gain for a next frame when a current frame is normal according to an embodiment. In accordance with these actions, gain may be changed even if the current frame is normal. In an embodiment, this has the effect of improving image quality for subsequent frames. It may also have the effect of stabilizing the scanned-beam system. At block 2102, the actions begin.

At block 2104, a determination is made as to whether the histogram indicates that gray scale colors fall at the minimum or maximum of the histogram. If so, the actions continue at block 2126 of FIG. 21B; otherwise, the actions continue at block 2108.

At block 2108, a variable (e.g., Point) may be set equal to an interval point closest to the mean of the current histogram. A histogram may be divided into equal intervals. For example, a histogram with 256 values may be divided into 16 intervals. An interval point is a point at the beginning or end of any interval. Each point may be associated with an index. For example, 1 may be associated with an interval point corresponding to 16 on the histogram, 2 may be associated with an interval point corresponding to 32 on the histogram, and so forth. To set the Point variable, the interval point closest to the mean of the current histogram may be found.

In subsequent actions, gain may be determined using the Point variable. Selecting a larger interval (and hence fewer intervals total for a given histogram) may have the effect of quickly moving a gain to create a “good” image but may also have undesirable side effects such as causing artifacts, jumpy convergence, or instability. Selecting too small of an interval, on the other hand (and hence more intervals total for a given histogram) may have the effect of not providing enough gain change to converge to a good image in a desired amount of time. In the exemplary MEMS based system, in an embodiment, one suitable interval size is 16. In other scanned-beam systems other interval sizes may be selected through varying the interval size until good, but not jumpy or instable, convergence occurs.

At block 2110, a determination is made as to whether the Point variable is greater than a selected PointMax value. If so, the actions continue at block 2112 at which the Point variable is set equal to the PointMax value. The PointMax value may be selected to meet the design goals listed above (e.g., to ensure that convergence does not occur too quickly). In the exemplary MEMS based system, in an embodiment, one suitable PointMax value is 12.

At block 2114, a determination is made as to whether the Point variable is less than a selected PointMin value. If so, the actions continue at block 2116 at which the Point variable is set equal to the PointMin value. The PointMin value may be selected to meet the design goals listed above (e.g., to ensure that convergence does not occur too slowly). In the exemplary MEMS based system, in an embodiment, one suitable PointMin value is 4.

At block 2118, a determination is made as to whether the Point variable is greater than a LastHighPoint value and the mean is greater than a selected value (e.g., NormalMean). If so, the actions continue at block 2120; otherwise the actions continue at block 2122. The LastHighPoint value may comprise a global variable selected to prevent unstable changes between subsequent frames based on implementation. When the Point variable exceeds LastHighPoint, the Point variable is set to the LastHighPoint for use in the next frame. In the exemplary MEMS based system, in an embodiment, one suitable NormalMean value is 128. In other embodiments, a dial or other input device may be provided that allows a user to dynamically change the NormalMean value. This may be useful, for example to allow a user to select a brighter or darker image as normal.

At block 2120, the Point value is set equal to the LastHighPoint value. When it is updated (i.e., at block 2146) the LastHighPoint value is set equal to the current Point value.

At block 2122, a determination is made as to whether the Point variable is less than a LastLowPoint value and the mean is less than NormalMean. If so, the actions continue at block 2124; otherwise the actions continue at block 2126. The LastLowPoint value may comprise a global variable selected to prevent unstable changes between subsequent frames based on implementation. When the Point variable becomes less than the LastLowPoint, the Point variable is set to the LastLowPoint for use in the next frame. LastHighPoint and LastLowPoint may be updated periodically to equal the current Point value as described in conjunction with FIG. 21C.

At block 2120, the Point value is set equal to the LastLowPoint value.

Turning to FIG. 21B, at block 2124, a variable (e.g., X) is set according to the following formula:

X=TMax−Width−TMin/Y

where TMax is a selected maximum threshold, width is the, width is the width of histogram for the current frame, TMin is a selected minimum threshold, and Y is a selected dividing value. In the exemplary MEMS based system, in an embodiment, some suitable values for TMax, TMin, and Y are 252, 0, and 4, respectively.

At block 2126, if the absolute value of X<PointMin then a variable (e.g., GainAdjust) is set to 0 at block 2128. Otherwise, the variable is set to X/PointMin at block 2130. At block 2132, the gain is set to a selected default gain plus the GainAdjust. In the exemplary MEMS based system, in an embodiment, one suitable default gain is approximately 1.

At block 2196, the actions continue at block 2025 of FIG. 20.

Turning to FIG. 21C, at block 2140, GainAdjust is set according to the following formula:

GainAdjust=IntervalPoint(Point)−Mean/X

Where IntervalPoint is the point to which Point corresponds (e.g., Point 1 corresponds to 16, Point 2 corresponds to 32, and so forth), Mean is the mean of the histogram for the current frame, and X is a selected dividing factor. In the exemplary MEMS based system, in an embodiment, one suitable X is 4.

At block 2142, a determination is made as to whether the absolute value of GainAdjust<a selected variable (e.g., PointMin). This may be done to avoid unnecessary adjusting of the gain. If the absolute value of the gain adjustment is too small, no gain adjustment may be needed.

If so, the actions continue at block 2144 at which the GainAdjust is set equal to 0; otherwise, the actions continue at block 2146. In the exemplary MEMS based system, in an embodiment, one suitable PointMin value is 4.

At block 2146, variables (e.g., LastHP and LastLP) are set equal to the point variable. These variables may be used in a gain adjustment for a subsequent frame at blocks 2118-2124 of FIG. 21A.

At block 2148, a determination is made as to whether the mean is greater than a selected value (e.g., NormalMean) and whether the GainAdjust is greater than 0. If so, the actions continue at block 2150 at which the GainAdjust is set equal to 0; otherwise, the actions continue at block 2152. When the mean is greater than the NormalMean, this means that the current frame is too bright. If, at the same time, GainAdjust is also greater then zero, this means that unless the GainAdjust is changed, the gain will increase for the next frame. Increasing the gain is not desirable when the current frame is already too bright. Thus, when this condition occurs, the GainAdjust may be set to 0. In the exemplary MEMS based system, in an embodiment, one suitable NormalMean value is 128. In other embodiments, a dial or other input device may be provided that allows a user to dynamically change the NormalMean value.

At block 2152, the gain is set to a selected default gain plus the GainAdjust calculated above. In the exemplary MEMS based system, in an embodiment, one suitable default gain is approximately 1.

At block 2196, the actions continue at block 2025 of FIG. 20.

In an embodiment, one or more input mechanisms (e.g., dials, keyboard, mouse, or the like) may be provided that allows a user to dynamically change any of the values or thresholds mentioned above. For example, the user may be able to select minimum, maximum, width, normal mean value, and so forth to vary how an image is judged (e.g., dark, undersaturated, bright, oversaturated, and so forth) and how offset and gain are calculated for obtaining a subsequent frame.

Those skilled in the art will recognize that the state of the art has progressed to the point where there is often little distinction between hardware and software implementations of aspects of the subject matter described herein. The use of hardware or software is generally (but not always, in that in certain contexts the choice between hardware and software can become significant) a design choice representing cost vs. efficiency tradeoffs. Those having skill in the art will appreciate that there are various vehicles by which processes, systems, or other technologies described herein may be implemented (e.g., by hardware, software, or firmware), and that the preferred vehicle may vary with the context in which the processes, systems, or other technologies are deployed.

For example, if an implementer determines that speed and accuracy are paramount, the implementer may opt for a mainly hardware or firmware vehicle; alternatively, if flexibility is paramount, the implementer may opt for a mainly software implementation; or, yet again alternatively, the implementer may opt for some combination of hardware, software, or firmware. Hence, there are several possible vehicles by which the processes, devices, or other technologies described herein may be implemented, wherein the vehicle to be utilized is a choice dependent upon the context in which the vehicle will be deployed and the specific concerns (e.g., speed, flexibility, or predictability) of the implementer, any of which may vary. Those skilled in the art will also recognize that an embodiment involving optics may involve optically-oriented hardware, software, or firmware.

The foregoing detailed description has set forth aspects of the subject matter described herein via the use of block diagrams, flow diagrams, or examples. Insofar as such block diagrams, flow diagrams, or examples are associated with one or more actions, functions, or operations, it will be understood by those within the art that each action, function, or operation or set of actions, functions, or operations associated with such block diagrams, flow diagrams, or examples may be implemented, individually or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will also recognize that aspects of the subject matter described herein, in whole or in part, can be equivalently implemented in standard integrated circuits, as one or more computer programs running on one or more computers, as one or more programs running on one or more processors, as firmware, or as virtually any combination thereof, and that designing the circuitry or writing the code for the software and or firmware would be well within the skill of one of skill in the art in light of this disclosure. In addition, those skilled in the art will appreciate that aspects of the subject matter described herein are capable of being distributed as a program product in a variety of forms, and that an illustrative embodiment of the subject matter described herein applies equally regardless of the particular type of machine-readable media used to actually carry out the distribution.

Those skilled in the art will recognize that the aspects described herein which may be implemented, individually or collectively, by a wide range of hardware, software, firmware, or any combination thereof may be viewed as being composed of various types of “circuitry.” Consequently, as used herein “circuitry” includes electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out aspects of the subject matter described herein, or a microprocessor configured by a computer program which at least partially carries out aspects of the subject matter described herein), electrical circuitry forming a memory device (e.g., forms of random access memory), and electrical circuitry forming a communications device (e.g., a modem, communications switch, or optical-electrical equipment). In an embodiment, circuitry may also include biological material, optical devices, mechanical device, some combination thereof, or the like capable of implementing logic or carrying out actions associated therewith.

As can be seen from the foregoing detailed description, there is provided aspects for improving image quality of obtained image frames. While the subject matter described herein is susceptible to various modifications and alternative constructions, certain illustrated embodiments thereof are shown in the drawings and have been described above in detail. It should be understood, however, that there is no intention to limit the claimed subject matter to the specific aspects described herein, but on the contrary, the intention is to cover all modifications, alternative constructions, and equivalents falling within the spirit and scope of the subject matter described herein.

What is claimed is:

1. A machine-readable medium having machine-executable instructions, which when executed perform actions, comprising:
obtaining an image that was created by a scanned beam image capture device;
creating a data structure that represents brightnesses of pixels corresponding to the image;
making an image quality judgment regarding the image using the data structure; and
in response to the image quality judgment, adjusting a parameter in preparation for obtaining a subsequent image.

2. The machine-readable medium of claim 1, wherein the data structure comprises a histogram.

3. The machine-readable medium of claim 2, wherein creating a data structure that represents brightnesses of pixels corresponding to the image comprises creating a gray scale image from the image and performing noise reduction.

4. The machine-readable medium of claim 3, wherein the image is in RGB format including a red component, a green component, and a blue component for each pixel of the image, and wherein creating a gray scale image from the image comprises multiplying the red component of a pixel by 0.21, the green component of a pixel by 0.27, and the blue component of a pixel by 0.07 to obtain a gray scale pixel.

5. The machine-readable medium of claim 3, wherein performing noise reduction comprises creating a reduced histogram from the histogram, wherein the reduced histogram includes fewer elements than the histogram.

6. The machine-readable medium of claim 5, wherein performing noise reduction further comprises integrally dividing elements of the reduced histogram by a noise factor.

7. The machine-readable medium of claim 3, further comprising computing a mean of the histogram, finding a maximum, minimum, and width of the histogram, and computing an oversaturation value and a glare value.

8. The machine-readable medium of claim 1, wherein the parameter comprises an offset of a detector employed to obtain the image.

9. The machine-readable medium of claim 1, wherein the parameter comprises a gain of a detector employed to obtain the image.

10. In a scanned-beam system including an image capturing device, a method, comprising:
judging an image to have one of a plurality of image characteristics, wherein the plurality of image characteristics at least include undersaturated, dark, oversaturated, bright, and normal; and
adjusting one or more of a gain and an offset of the image capturing device based at least in part on the characteristic.

11. The method of claim 10, further comprising creating a histogram from the image and determining a mean, minimum, maximum, and width of the histogram, and using one or more of the mean, minimum, and maximum in judging the image.

12. The method of claim 11 wherein the image is judged to have a characteristic of normal and wherein adjusting one or more of a gain and an offset of the image capturing device based at least in part on the characteristic comprises dividing the histogram into intervals, each interval having an interval point at each end and determining which interval point is closest to the mean.

13. The method of claim 12, wherein adjusting one or more of a gain and an offset of the image capturing device based at least in part on the characteristic comprises adjusting the gain by a fraction of the interval point.

14. The method of claim 11, wherein the histogram is determined from a portion of the image.

15. The method of claim 10, wherein adjusting one or more of a gain and an offset of the image capturing device is further based on input received from a user.

16. The method of claim 15, wherein the input corresponds to a threshold or normal mean.

17. An image capturing device, comprising:
a light emitter operable to scan light in a pattern that substantially covers an area;
a non-imaging detector operable to detect light reflected from the area; and
a controller operable to create an image from light detected by the non-imaging detector, to create a histogram using the image, to determine characteristics of the image using the histogram, and to control a sensitivity of the non-imaging detector in response to one or more of the characteristics of the image.

18. The image capturing device of claim 17, wherein the light emitter comprises a laser.

19. The image capturing device of claim 17, wherein the controller is further operable to control the intensity of the laser in response to one or more of the characteristics of the image.

20. A method, comprising:
scanning an area of a surface with a light;
detecting, with a non-imaging detector, at least part of the light that reflects from the area;
creating an image from the at least part of the light that reflects from the area;
creating a histogram based on the image;
determining a characteristic of the image based on the histogram; and
adjusting a gain of the non-imaging detector based on the characteristic.

21. The method of claim 20, wherein scanning an area of a surface with a light comprises directing the light in a pattern that periodically traces over substantially all of the area.

22. The method of claim 21 wherein the light comprises laser light.

23. The method of claim 22, wherein the scanning is performed by a light directing element of a camera.

24. The method of claim 23, wherein the camera comprises an endoscope.

25. The method of claim 20, wherein the non-imaging detector comprises a PIN diode, an avalanche photodiode, or a photomultiplier tube.

27. The method of claim 20, further comprising converting the image to gray scale in conjunction with creating the histogram.

28. The method of claim 20, wherein the characteristic comprises normal, dark, undersaturated, oversaturated, or bright.

29. The method of claim 20, wherein adjusting a gain of the non-imaging detector, comprises changing the gain of an amplifier associated with the detector.

30. The method of claim 20, wherein adjusting a gain of the non-imaging detector comprises modifying a bias voltage of an amplifier associated with the detector.

31. A method, comprising:
scanning a light in a pattern over a surface to obtain an image corresponding to the surface;
computing a first histogram of the image;
determining a characteristic of the first histogram;
making an image quality judgment based at least in part on the characteristic; and
based at least in part on the image quality judgment, determining an intensity of the light to use for obtaining a subsequent image.

32. The method of claim 31, wherein the light comprises laser light emitted by an endoscope and wherein the surface comprises an interior area of a human body.

33. The method of claim 31, wherein computing a first histogram of the image comprises a conversion of the image into gray scale.

34. The method of claim 31, further comprising creating a second histogram that has fewer values than the first histogram and placing values from the first histogram into the second histogram.

35. The method of claim 31, wherein computing a first histogram comprises applying a noise reduction algorithm.

36. The method of claim 31, wherein computing a first histogram of the image comprises sampling the image at fewer than every pixel of the image.

37. The machine-readable medium of claim 1, wherein the action of obtaining an image that was created by a scanned beam image capture device comprises obtaining one of a plurality of image portions; and
wherein the action of adjusting a parameter in preparation for obtaining a subsequent image comprises adjusting a parameter for the one of the plurality of image portions.

38. The machine-readable medium of claim 37, wherein the machine readable medium further has machine-executable instructions, which when executed perform the action of repeating the recited actions for each of the plurality of image portions that make up substantially an entire image.

39. The method of claim 10 wherein judging an image comprises judging one of a plurality of image portions; and
wherein adjusting one or more of a gain and an offset of the image capturing device based at least in part on the characteristic comprises adjusting one or more of the gain and the offset of the image capturing device for the one of a plurality of image portions.

40. The method of claim 39, further comprising repeating the judging an image and adjusting one or more of the gain and the offset for each of the plurality of image portions that make up substantially an entire image.

41. The image capturing device of claim 17, wherein the controller is further operable to create a plurality of portions forming an image from light detected by the non-imaging detector, to create a plurality of histograms using the plurality of image portions, to determine characteristics of the plurality of image portions using the respective histograms, and to control a sensitivity of the non-imaging detector for each of the plurality of image portions in response to the one or more of the characteristics of the respective image portion.

42. The method of claim 20, wherein the area comprises a portion of a field of view of the scanned surface.

43. The method of claim 42, wherein steps are repeated for each area of the field of view.

44. The method of claim 31 wherein the image comprises one of a plurality of image portions; and
wherein determining an intensity of the light to use for obtaining a subsequent image comprises determining the intensity of the light for use in obtaining the corresponding one of a plurality of image portions.

45. The method of claim 44 wherein the steps are repeated for each of the plurality of image portions.
